(19) United States
(12) Patent Application Publication
(10) Pub. No.: US 2014/0148552 A1
(43) Pub. Date: May 29, 2014

(54) Biomimetic Agent For Anti-Biofouling Coating And Method For Making The Same

(71) Applicant: CHUNG YUAN CHRISTIAN UNIVERSITY, Tao-Yuan (TW)

(72) Inventors: Yung Chang, Taipei City (TW); Ruoh-Chyu Ruaan, Taipei City (TW); Hui-Shan Yang, Taipei City (TW); Kueir-Rarn Lee, Taipei City (TW); Juin-Yih Lai, Taipei City (TW)

(73) Assignee: CHUNG YUAN CHRISTIAN UNIVERSITY, Tao-Yuan (TW)

(21) Appl. No.: 13/690,202

(22) Filed: Nov. 30, 2012

(30) Foreign Application Priority Data
Nov. 29, 2012 (TW) 101144643

(51) Int. Cl. C09D 5/16

(52) U.S. Cl. CPC C09D 5/1637
USPC 525/94

(57) ABSTRACT

The present invention provides a biomimetic agent for anti-fouling coating and a method for making the same. The biomimetic agent comprises a block, random, or alternating copolymer having a general formula (1): AUₙBUₘ, where AU represents a repeating unit comprising an anchoring moiety, BU represents a repeating unit comprising a zwitterionic moiety or a pseudo-zwitterionic moiety, m is an integer of 5˜120 and n is an integer of 5˜120.

### BACKGROUND OF THE INVENTION

1. Field of the Invention

The present invention is generally related to a biomimetic agent, and more particularly to a biomimetic agent for anti-biofouling coating and a method for making the same.

2. Description of the Prior Art

At present, anti-biofouling surface treatment is one of the important techniques in various applications. An anti-biofouling surface indicates a biomolecule adhering resistant surface where the biomolecule is, for example, protein, blood, cells, bacteria, etc. The coating agent used in anti-biofouling surface treatment is generally considered to make a surface become hydrophilic in assisting of anti-biofouling according to prior arts, but the anti-biofouling effect in practice is not enough.

Furthermore, it have been reported that zwitterionic molecules or polymers are used as the anti-biofouling agent. For example, Wu et al. (L. Wu, J. Jasinski, S. Krishnan, J. Appl. Polymer Science, Vol, 124, 2154 (2012)) disclosed a block copolymer comprising a betaine moiety, sulfobetaine moiety or carboxybetaine moiety as an anti-biofouling agent and anti-biofouling surface treatment by spin-coating the anti-biofouling agent. However, from FIG. 8 of the report, the experiment of the protein adsorption effect shows that the anti-biofouling agent does not have 80% of protein adsorption resistance and thus is not an excellent anti-biofouling agent having less than 20% of protein adsorption. Besides, the anti-biofouling effect also includes other molecules such as blood, cells, bacteria resistance and these properties were not discussed in the report.

According to prior arts, although in general a surface being hydrophilic or having zwitterionic moieties shows anti-biofouling, an excellent anti-biofouling surface to be useful should be treated by a novel anti-biofouling agent comprising a specific structure.

### SUMMARY OF THE INVENTION

In accordance with the present invention, a biomimetic agent for anti-biofouling coating and a method for making the same are provided. The present invention utilizes a polymer comprising a specific structure and zwitterionic or pseudo-zwitterionic moieties as an effective component of anti-biofouling to achieve anti-biofouling effect.

One objective of the present invention is to provide a biomimetic agent for anti-biofouling coating to apply to various surfaces, such as polymeric, metallic, ceramic and porous surfaces, by a simple well-known coating method, such as dipping, spin-coating and so forth.

One objective of the present invention is to provide a method for making a biomimetic agent for anti-biofouling coating to use a simple well-known coating method, such as dipping, spin-coating and so forth, to be easily applied to surfaces with a large area and porous surfaces. Therefore, mass-production can be easily implemented and no special or large-scaled equipment is required to reduce production cost.

Accordingly, the present invention discloses a biomimetic agent for anti-biofouling coating, comprising a block, random or alternating copolymer having a general formula (1); AUₙBUₘ wherein AU represents a repeating unit comprising an anchoring moiety, being a methylene moiety with substituents R¹ and R² having a structure of formula (2); —CR¹R²—; BU represents a repeating unit comprising a zwitterionic moiety or a pseudo-zwitterionic moiety, being an ethylene moiety with a substituent R³ having a structure of formula (3): —CH₂CR³H— or a propylene moiety with substituents R⁴ and R⁵ having a structure of formula (4): —CR⁴HCH₂CR⁵H—; m is an integer of 5˜120; n is an integer of 5˜120; R¹ represents a C3˜18 chained, branched or cyclic alkyl moiety, ester moiety (i.e. —COOR^{x}, where R^{x} represents a C3˜18 chained, branched or cyclic alkyl moiety, aryl moiety having substituent(s) of C1˜18 alkyl, or C5˜12 heteroaryl moiety), phenyl moiety having substituent(s) of C1˜18 alkyl, or C5˜12 heteroaryl moiety; R² represents a hydrogen atom (H) or methyl moiety (CH₃); R³ represents —COOR′ or —CONR″H; R⁵ represents —COOR′ or —CONR″H when R⁴ represents a hydrogen atom or R⁵ represents a cationic moiety when R⁴ represents a carboxylic moiety; R′ and R″ individually represent a betaine moiety, sulfobetaine moiety or carboxybetaine moiety.

Furthermore, the present invention discloses a method for making a biomimetic agent for anti-biofouling coating, comprising the following steps: providing a monomer comprising an anchoring moiety; providing a monomer comprising a zwitterionic moiety or a pseudo-zwitterionic moiety; and performing atomic transfer radical polymerization under existence of a catalyst and a polymerization initiator in nitrogen environment to have the monomer comprising an anchoring moiety and the monomer comprising a zwitterionic moiety or a pseudo-zwitterionic moiety react to form a block, random or alternating copolymer having a general formula (1): AUₙBUₘ.

Moreover, the present invention discloses a coating composition for anti-biofouling, comprising: the above mentioned biomimetic agent and a solvent.

According to the biomimetic agent for anti-biofouling coating and the method for making the same of the present invention, a polymer comprising a specific structure and zwitterionic or pseudo-zwitterionic moieties is used as an effective component of anti-biofouling to achieve excellent anti-biofouling effect. Besides, the biomimetic agent can be applied to surfaces with a large area and porous surfaces easily by a simple well-known coating method, such as dipping, spin-coating and so forth. Therefore, mass-production can be easily implemented and no special or large-scaled equipment is required to reduce production cost.

### DESCRIPTION OF THE PREFERRED EMBODIMENTS

What is probed into the invention is a biomimetic agent for anti-biofouling coating. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

The biomimetic agent for anti-biofouling coating according to the present invention can be coated on a surface to perform anti-biofouling surface treatment so as to achieve the effect of anti-biofouling. For example, the treated surface becomes resisting adherence of biomolecules like protein, blood, cell, bacteria, etc. The biomimetic agent according to the present invention is a compound having a structure imitating nature of a biomolecule. The biomimetic agent according to the present invention has a specific structure and zwitterionic or pseudo-zwitterionic moieties to possess the anti-biofouling characteristic. Besides, usually the coating agent usually has a problem of adhering to a treating surface. The coating agent according to the present invention uses a specific anchoring moiety not only to solve the adherence problem but also to provide excellent properties of coating, film-forming, and surface adherence.

In one embodiment of the invention, a biomimetic agent for anti-biofouling coating is disclosed. The biomimetic agent comprising a block, random or alternating copolymer having a general formula (1): AUₙBUₘ wherein AU represents a repeating unit comprising an anchoring moiety, being a methylene moiety with substituents R¹ and R² having a structure of formula (2): —CR¹R²—; BU represents a repeating unit comprising a zwitterionic moiety or a pseudo-zwitterionic moiety, being an ethylene moiety with a substituent R³ having a structure of formula (3): —CH₂CR³H— or a propylene moiety with substituents R⁴ and R⁵ having a structure of formula (4): —CR⁴HCH₂CR⁵H—; m is an integer of 5˜120; n is an integer of 5˜120.

Specifically, the biomimetic agent has the following structure shown by formula (A) or (B).

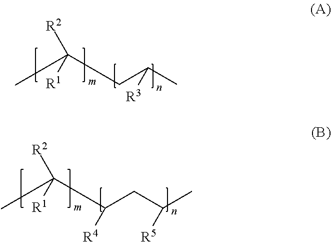

In the formula (A) an (B), R¹, R², R³, R⁴ and R⁵ represent the same moieties as the above.

R¹ represents a C3˜18 chained, branched or cyclic alkyl moiety, ester moiety (i.e. —COOR^{x}, where R^{x} represents a C3˜18 chained, branched or cyclic alkyl moiety, aryl moiety having substituent(s) of C1˜18 alkyl, or C5˜12 heteroaryl moiety), phenyl moiety having substituent(s) of C1˜18 alkyl, or C5˜12 heteroaryl moiety. “C3˜18”, “C1˜18” or “C5˜12” means the number of carbon atoms in the moiety. That is, for example, C3˜18 chained, branched or cyclic alkyl moiety means alkyl having three carbon atoms˜eighteen carbon atoms, such as propyl, isopropyl, butyl, isobutyl, pentyl, hexyl, heptyl, octyl, nonyl, undecyl, dodecyl, tridecyl, tetradecyl, pentadecyl, hexadecyl, heptadecyl, octadecyl, cyclopentyl, cyclohexyl, cycloheptyl, etc. The ester moiety (i.e. —COOR^{x}), for example, is phenyl, tolyl, benzyl, 2-pyrrolidone-1-yl, 2-pyridyl, phenoxycarbonyl (—C(═O)—OC₆H₅), benzyloxycarbonyl (—C(═O)—OCH₂C₆H₅) and N,N-diphenylamino-para-phenoxycarbonyl

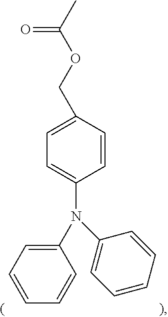 [SMILES: CC(=O)OCc1ccc(N(c2ccccc2)c2ccccc2)cc1]

etc. The aryl moiety, for example, is phenyl, tolyl, benzyl, etc. The C5˜12 heteroaryl moiety, for example, is 2-pyrrolidone-1-yl, 2-pyridyl, etc. The open dashed symbol “—” indicates the linkage bond and the following “—” also has the same meaning.

R² represents a hydrogen atom (H) or methyl moiety (CH₃). R³ represents —COOR′ or —CONR″H. R⁵ represents —COOR′ or —CONR″H when R⁴ represents a hydrogen atom or R⁵ represents a cationic moiety when R⁴ represents a carboxylic moiety. R′ and R″ individually represent a betaine moiety, sulfobetaine moiety or carboxybetaine moiety. Preferably, m is an integer of 10˜80; n is an integer of 10˜80. More preferably, m is an integer of 20˜40; n is an integer of 20˜40.

The cationic moiety represented by R⁵, for example, is N,N-dimethylammnio-ethylene-1-amino-vinyl (—C(═CH₂)NH₂CH₂CH₂N(CH₃)₂H) N,N-dimethylammnio-propylene-1-amino-vinyl (—C(═CH₂)NH₂CH₂CH₂CH₂N(CH₃)₂H) N,N-dimethylammnio-butylene-1-amino-vinyl (—C(═CH₂)NH₂CH₂CH₂CH₂CH₂N(CH₃)₂H) and N,N-dimethylammnio-pentylene-1-amino-vinyl (—C(═CH₂)NH₂CH₂CH₂CH₂CH₂CH₂N(CH₃)₂H).

Specifically, the biomimetic agent has the following structure shown by formula (A-1)˜(A-21)

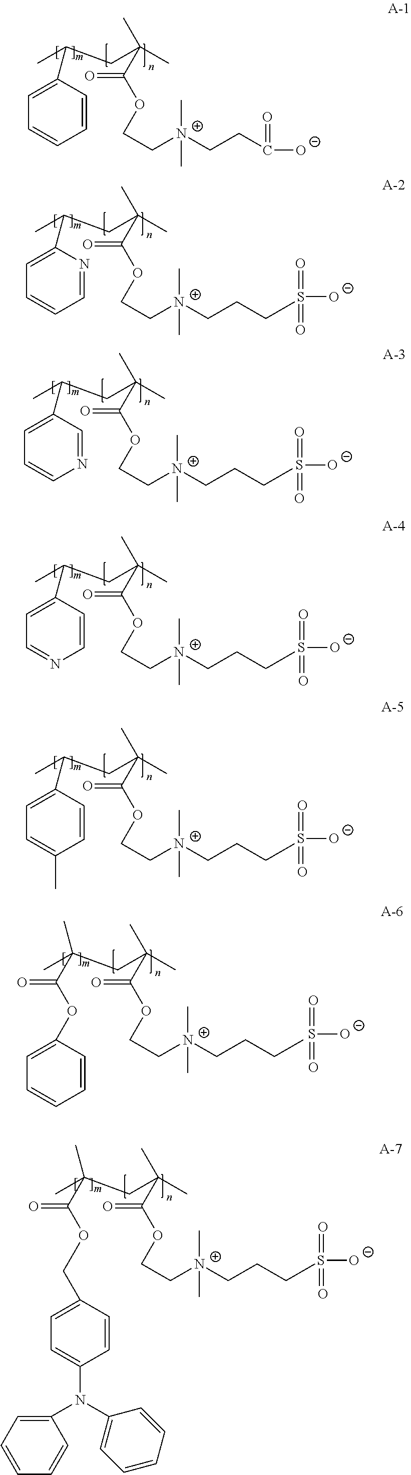

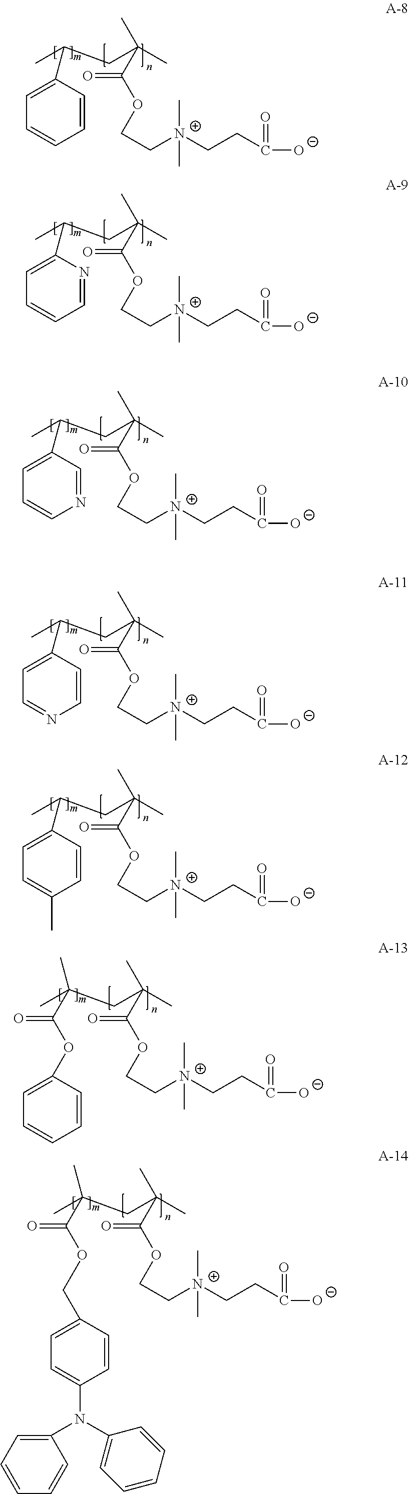

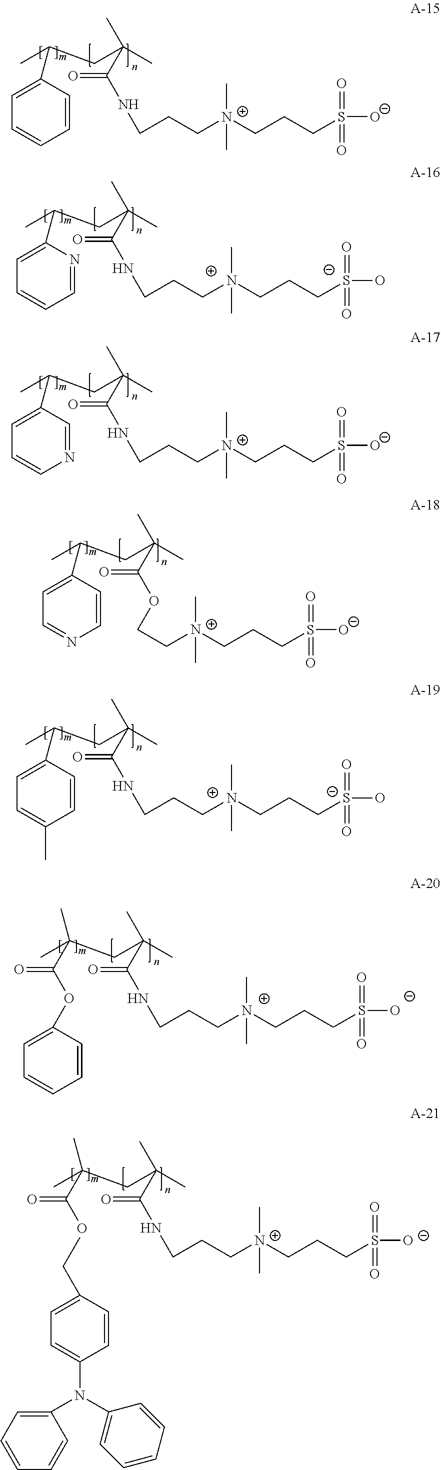

The above biomimetic agents with formula (A-1)˜(A-21) comprise rod-like anchoring moieties where m and n have the same meaning as the above. The biomimetic agents with formula (A-1)˜(A-21) can be a block, random or alternating copolymer.

Furthermore, the biomimetic agent has the following structure shown by formula (A-22)˜(A-33). The following biomimetic agents with formula (A-22)˜(A-33) comprise comb-like anchoring moieties where m and n have the same meaning as the above. The biomimetic agents with formula (A-22)˜(A-33) can be a block, random or alternating copolymer.

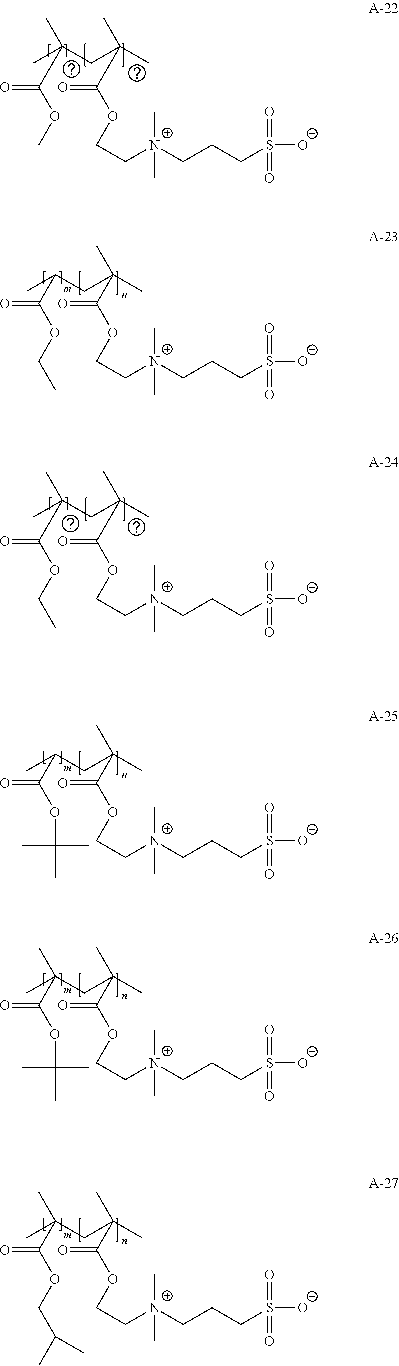

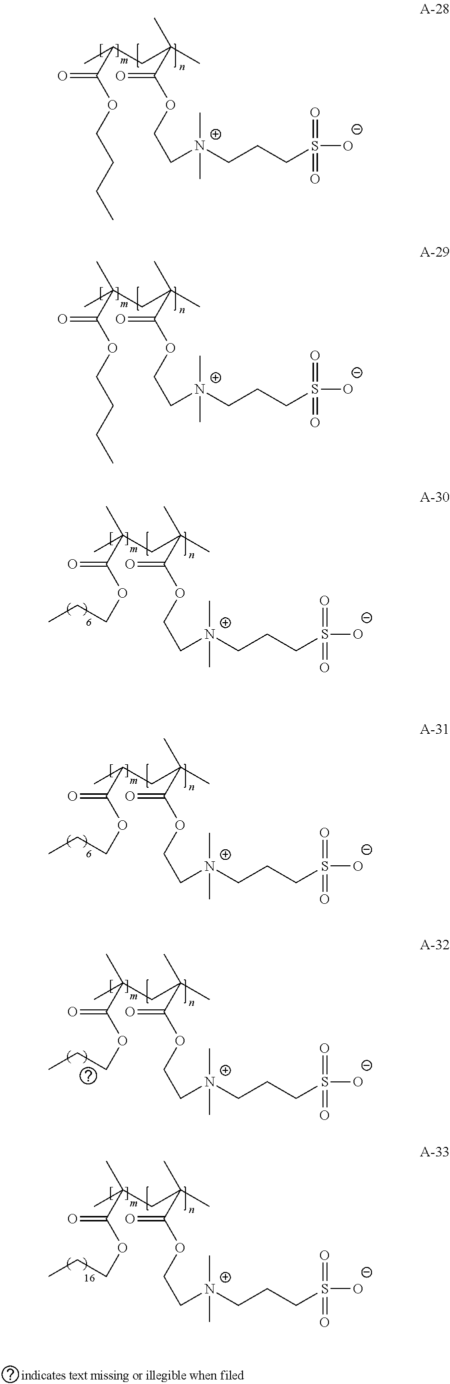

Furthermore, the biomimetic agent has the following structure shown by formula (B-1) or (B-2).

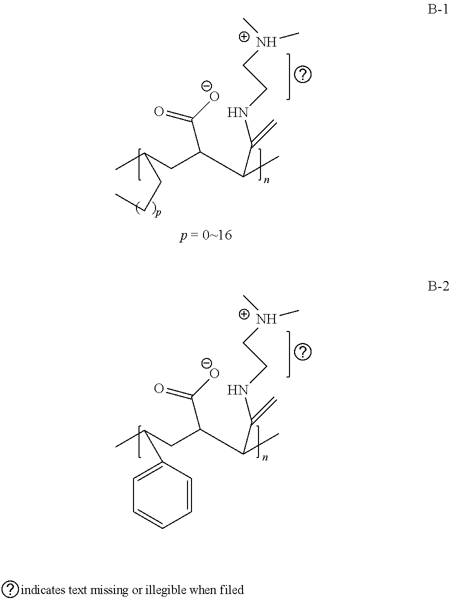

The biomimetic agents with formula (B-1)˜(-2) can be an alternating copolymer.

Furthermore, the biomimetic agent has the following structure shown by formula (B-3).

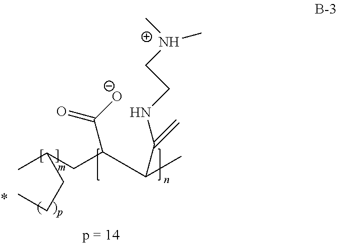

The biomimetic agents with formula (B-3) can be a block or random copolymer.

Furthermore, the biomimetic agent has the following structure shown by formula (C-1)˜(C-6).

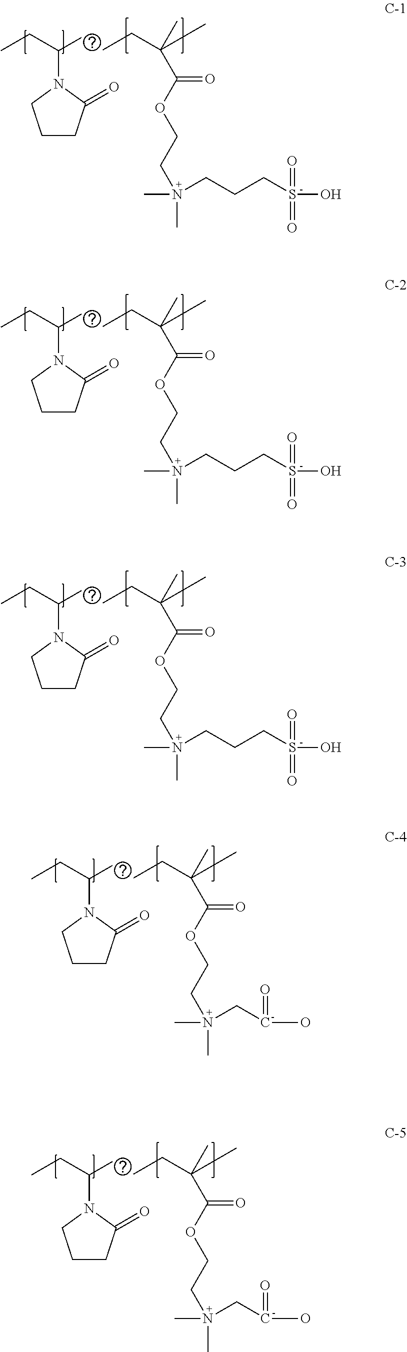

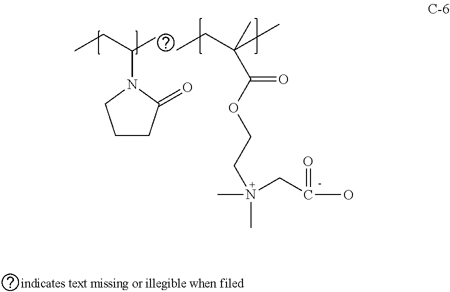

The biomimetic agents with formula (C-1)˜(C-6) can be a block, random or alternating copolymer comprising a cross-linkable moiety. After the biomimetic agents with formula (C-1)˜(C-6) is coated on a surface, the cross-linkable moiety can cross-link with each other by heating.

### PRODUCTION EXAMPLE 1

### Preparing A-33 (PODA-b-PSBMA)

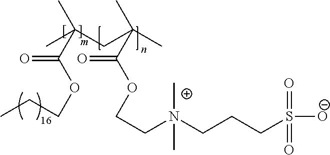

Octadecyl acrylate (ODA) was dissolved in toluene to form a 40 wt % solution. By atomic transfer radical polymerization (ATRP), under existence of CuBr/2,2′-bipyridine (CuBr/bpy) as the catalyst and methyl 2-bromopropionate (MBrP) as the initiator, in nitrogen environment, [ODA]/[MBrP]/[CuBr]/[bpy] (molar ratio) being 6/1/12˜120/1/1/2 was used to react for 24 hrs at 120° C. Then, by removing the catalyst and initiator, PODA was obtained.

By ATRP, poly(2-(dimethylamino)ethyl methacrylate) (DMAEMA) and PODA reacted with each other with a molar ratio of [DMAEMA]/[PODA]/[CuBr]/[bpy] being 5/1/1/2˜100/1/1/2 for 24 hrs at 120° C. to polymerize. Then, by removing the catalyst and initiator, the copolymer A-33P (Poly(octadecyl acrylate)-b-poly(2-(dimethylamino)ethyl methacrylate)) was obtained. 1,3-propanesultone and the copolymer A-33P were dissolved in THF to betainize the copolymer A-33P in atmospheric environment at room temperature for 24 hrs to obtain A-33.

### PRODUCTION EXAMPLE 2

### Preparing B-3 (Poly((Octadecyl Acrylate)-Alt-((Acrylic Acid)-(N-(3-(Dimethylamino)Propyl) Acrylamide))); Poly(ODA-Alt-(AA-DMAPAMMI))

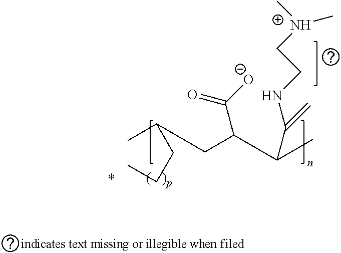

2 ml of 10 wt % PMAO (poly(maleic anhydride alt 1-octadecene)) solution (solvent is THF) was prepare. Dimethylethylenediamine (DMEA) 3.2 g was dissolved in THF (8 ml) to form a DMEA solution. PMAO solution was then added into DMEA solution to form precipitate. By centrifugal separation and extraction, the copolymer B-3 was obtained.

Other biomimetic agents for anti-biofouling coating in the above can be made or synthesized by similar method shown in the production examples 1 and 2 or modified method together with well-known polymerization methods. According to experiments conducted by the inventors, the biomimetic agents for anti-biofouling coating according to the invention show good resistance in adherence of biomolecules like protein (plasma protein, Fibrinogen, bovine serum albumin (BSA)), blood (such red blood, leukocyte, platelet), cell (human cell, Fibroblasts, Keratinocytes), bacteria (S. epidermidis, E. coli), etc. That is, less than 20% of biomolecules will, adhere on the surface treated by the biomimetic agent for anti-biofouling coating according to the invention. Under the better condition, less than 2% of biomolecules will adhere on the treated surface. The invention also discloses a coating composition for anti-biofouling, comprising: the above mentioned biomimetic agent according to the invention and a solvent. The solvent can be, for example, water, phosphate-buffered saline, ethanol, methanol, etc. The biomimetic agent for anti-biofouling coating according to the invention can be applied to a surface such as polymeric surface like polytetrafluoroethylene (PTFE), polyvinylidene difluoride (PVDF), polystyrene (PS), polypropylene (PP), polyvinyl chloride (PVC) or inorganic oxide surface like SiO₂, Al₂O₃. In addition, a metallic surface like Ti, Fe can be treated by the biomimetic agent for anti-biofouling coating according to the invention.

In conclusion, according to the biomimetic agent for anti-biofouling coating and the method for making the same of the present invention, a polymer comprising a specific structure and zwitterionic or pseudo-zwitterionic moieties is used as an effective component of anti-biofouling to achieve excellent anti-biofouling effect. Besides, the biomimetic agent can be applied to surfaces with a large area and porous surfaces easily by a simple well-known coating method, such as dipping, spin-coating and so forth. Therefore, mass-production can be easily implemented and no special or large-scaled equipment is required to reduce production cost.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A biomimetic agent for anti-biofouling coating, comprising a block, random or alternating copolymer having a general formula (1): AUₙBUₘ wherein
AU represents a repeating unit comprising an anchoring moiety, being a methylene moiety with substituents R¹ and R² having a structure of formula (2): —CR¹R²—;
BU represents a repeating unit comprising a zwitterionic moiety or a pseudo-zwitterionic moiety, being an ethylene moiety with a substituent R³ having a structure of formula (3): —CH₂CR³H— or a propylene moiety with substituents R⁴ and R⁵ having a structure of formula (4): —CR⁴HCH₂CR⁵H—;
m is an integer of 5˜120;
n is an integer of 5˜120;
R¹ represents a C3˜18 chained, branched or cyclic alkyl moiety, ester moiety (i.e. —COOR^{x}, where R^{x} represents a C3˜18 chained, branched or cyclic alkyl moiety, aryl moiety having substituent(s) of C1˜18 alkyl, or C5˜12 heteroaryl moiety), phenyl moiety having substituent(s) of C1˜18 alkyl, or C5˜12 heteroaryl moiety;
R² represents a hydrogen atom (H) or methyl moiety (CH₃);
R³ represents —COOR′ or —CONR″H;
R⁵ represents —COOR′ or —CONR″H when R⁴ represents a hydrogen atom or R⁵ represents a cationic moiety when R⁴ represents a carboxylic moiety;
R′ and R″ individually represent a betaine moiety, sulfobetaine moiety or carboxybetaine moiety.

2. The agent according to claim 1, wherein the repeating unit AU has a rod-like structure.

3. The agent according to claim 1, wherein the repeating unit AU has a brush-like structure.

4. The agent according to claim 1, wherein the repeating unit AU has a comb-like structure.

5. The agent according to claim 1, wherein the repeating unit AU comprises a cross-linkable moiety.

6. The agent according to claim 1, wherein R¹ is selected from the group consisting of the following: phenyl, tolyl, benzyl, 2-pyrrolidone-1-yl, 2-pyridyl, phenoxycarbonyl (—C(═O)—OC₆H₅), benzyloxycarbonyl (—C(═O)—OCH₂C₆H₅) and N,N-diphenylamino-para-phenoxycarbonyl

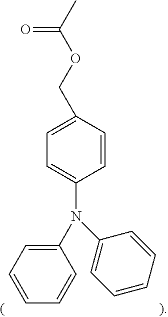 [SMILES: CC(=O)OCc1ccc(N(c2ccccc2)c2ccccc2)cc1]

7. The agent according to claim 1, wherein R¹ is selected from the group consisting of the following: octadecyloxycarbonyl, hexadecyloxycarbonyl, hexyloxycarbonyl, t-butyloxycarbonyl, octadecyl, hexadecyl and tetradecyl.

8. The agent according to claim 1, wherein AU is a methylene moiety with substituents; BU is a propylene moiety with substituents R⁴ and R⁵ having a structure of formula (4): —CR⁴HCH₂CR⁵H—; R¹ is octadecyl, hexadecyl or tetradecyl; R⁴ is carboxyl, R⁵ is N,N-dimethylammnio-ethylene-1-amino-vinyl (—C(═CH₂)NH₂CH₂CH₂N(CH₃)₂H); and the agent is a random or alternating copolymer.

9. The apparatus according to claim 1, wherein AU is a methylene moiety with substituents; BU is a propylene moiety with substituents R⁴ and R⁵ having a structure of formula (4): —CR⁴HCH₂CR⁵H—; R¹ is phenyl or tolyl; R⁴ is carboxyl, R⁵ is N,N-dimethylammnio-ethylene-1-amino-vinyl (—C(═CH₂)NH₂CH₂CH₂N(CH₃)₂H); and the agent is a random copolymer.

10. The agent according to claim 1, being selected from the group consisting of the following: polystyrene-b-poly(sulfobetaine methacrylate (formula (5)), 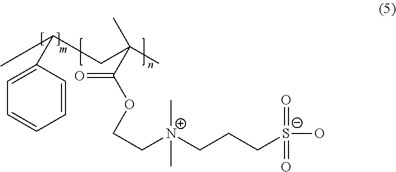
poly(octadecyl acrylate)-b-poly(sulfobetaine methacrylate) (formula (6)), 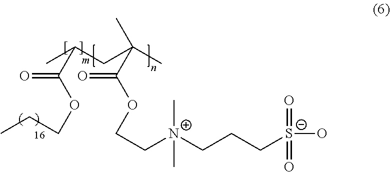
polyvinylpyrrolidone-r-poly(sulfobetaine methacrylate) (formula (7)) 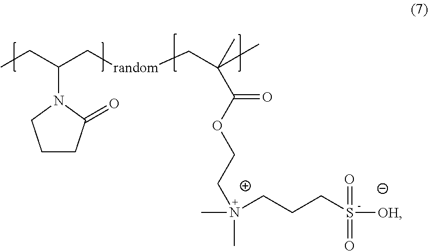
and
Poly((octadecyl acrylate)-alt-((acrylic acid)-(N-(3-(dimethylamino)propyl) acrylamide))) (formula (8))

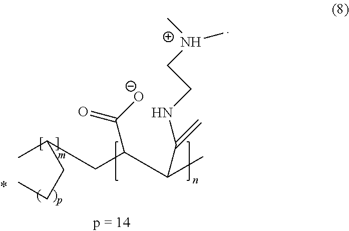

11. A method for making a biomimetic agent for anti-biofouling coating, comprising:
providing a monomer comprising an anchoring moiety;
providing a monomer comprising a zwitterionic moiety or a pseudo-zwitterionic moiety; and
performing atomic transfer radical polymerization under existence of a catalyst and a polymerization initiator in nitrogen environment to have the monomer comprising an anchoring moiety and the monomer comprising a zwitterionic moiety or a pseudo-zwitterionic moiety react to form a block, random or alternating copolymer having a general formula (1): AUₙBUₘ wherein
AU represents a repeating unit comprising an anchoring moiety, being a methylene moiety with substituents R¹ and R² having a structure of formula (2): —CR¹R²—;
BU represents a repeating unit comprising a zwitterionic moiety or a pseudo-zwitterionic moiety, being an ethylene moiety with a substituent R³ having a structure of formula (3): —CH₂CR³H— or a propylene moiety with substituents R⁴ and R⁵ having a structure of formula (4): —CR⁴HCH₂CR⁵H—;
m is an integer of 5˜120;
n is an integer of 5˜120;
R¹ represents a C3˜18 chained, branched or cyclic alkyl moiety, ester moiety (i.e. —COOR^{x}, where R^{x} represents a C3˜18 chained, branched or cyclic alkyl moiety, aryl moiety having substituent(s) of C1˜18 alkyl, or C5˜12 heteroaryl moiety), phenyl moiety having substituent(s) of C1˜18 alkyl, or C5˜12 heteroaryl moiety;
R² represents a hydrogen atom (H) or methyl moiety (CH₃);
R³ represents —COOR′ or —CONR″H;
R⁵ represents —COOR′ or —CONR″H when R⁴ represents a hydrogen atom or R⁵ represents a cationic moiety when R⁴ represents a carboxylic moiety;
R′ and R″ individually represent a betaine moiety, sulfobetaine moiety or carboxybetaine moiety.

12. The method according to claim 11, wherein the catalyst is CuBr/2,2′-bipyridine.

13. The method according to claim 11, wherein the polymerization initiator is methyl 2-bromopropionate.

14. The method according to claim 11, wherein the anchoring moiety is selected from the group consisting of the following: octadecyloxycarbonyl, hexadecyloxycarbonyl, hexyloxycarbonyl, t-butyloxycarbonyl, octadecyl, hexadecyl and tetradecyl.

15. The method according to claim 11, wherein the zwitterionic moiety is selected from the group consisting of the following: a betaine moiety, sulfobetaine moiety and carboxybetaine moiety.

16. The method according to claim 11, wherein the anchoring moiety is selected from the group consisting of the following: phenyl, tolyl, benzyl, 2-pyrrolidone-1-yl, 2-pyridyl, phenoxycarbonyl (—C(═O)—OC₆H₅), benzyloxycarbonyl (—C(═O)—OCH₂C₆H₅) and N,N-diphenylamino-para-phenoxycarbonyl 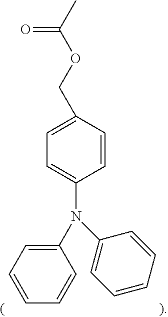 [SMILES: CC(=O)OCc1ccc(N(c2ccccc2)c2ccccc2)cc1]
